(19) United States
(12) Patent Application Publication
(10) Pub. No.: US 2005/0242778 A1
(43) Pub. Date: Nov. 3, 2005

(54) Controlling circuit for long-time battery retention

(76) Inventor: Yen-Hsi Lin, Hsintien City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/834,995

(22) Filed: Apr. 30, 2004

(51) Int. Cl. H02J 7/00

(52) U.S. Cl. 320/134

(57) ABSTRACT

A controlling circuit for long-time battery retention has a switch between a rechargeable battery and a protection circuit, a latch connected to the control end of the switch for controlling the connection and disconnection between the two switch ends of the switch, a controller connected to the latch for generating a first trigger signal to the latch to disconnect the switch and enable the rechargeable battery in a long-term retention state. A trigger is connected to an external charger source and the latch. The trigger generates a second trigger signal to control the switch to connect the rechargeable battery and the protection circuit when an electrical power is applied to the input end of the external charger source.

### FIELD OF THE INVENTION

The present invention relates to a controlling circuit for long-time battery retention, and more particularly to a controlling circuit for retaining the electricity of a low-capacity batter after a long idle period.

### BACKGROUND OF THE INVENTION

The essential issue for an electronic product, especially for a portable electronic product, is a durable and stable power source. A portable electronic product such as mobile phones and personal digital assistants (PDA) generally uses a rechargeable battery for as an electricity source. Moreover, the rechargeable battery is provided with a protection circuit in order to prevent damage thereto during charging.

Taking the rechargeable battery for a compact portable electronic product as an example, the rechargeable battery is charged to 70% of full electric capacity thereof before shipping to a user. This charging amount selection is aimed to reduce the damage risk due to temperature variation during shipping and to prevent exhausting electricity by an inevitable loss problem. A newly bought rechargeable battery has very low initial electricity. Therefore, the newly bought rechargeable generally needs 8-12 hours of initial charging time to prevent capacity reduction.

The rechargeable battery for a compact portable electronic product (such as a Bluetooth™ earphone or electronic watch) generally has a low electricity capacity because the power consumption of the compact portable electronic product is also low. Moreover, the above-mentioned rechargeable battery is also hard to detach or replace by user due to its tiny size. The stored electricity may be exhausted by the protection circuit thereof after a long idle period or a long shipping period to user. The rechargeable battery may malfunction to charge.

Taking a Bluetooth™ earphone as an example, a low capacity rechargeable battery can be used to reduce the cost and size of the Bluetooth™ earphone due to the low power consumption of the Bluetooth™ earphone. However, the stored electricity of the low capacity rechargeable battery may be exhausted by the protection circuit after a long idle period.

The protection circuit of the rechargeable battery in the Bluetooth™ earphone generally consumes about 200 μA, while the stored electricity of the rechargeable battery in the Bluetooth™ earphone is usually 80 mA-Hr. Therefore, this rechargeable battery can sustain only 2-3 weeks of idle time, and the rechargeable battery may not be recharged if this period expires. A rechargeable battery with a higher capacity (for example, 700 mA-Hr) may have a longer duration of about five months.

If a long period of time elapses during shipping of the Bluetooth™ earphone to a user from a distributor, the rechargeable battery in the Bluetooth™ earphone may fail for a recharging operation. This problem is hard to fix for user because the rechargeable battery is internally installed in the Bluetooth™ earphone and hard to remove. The Bluetooth™ earphone should be returned to the vendor for maintenance. This is tiresome to both user and vendor.

### SUMMARY OF THE INVENTION

It is the object of the present invention to provide a controlling circuit for retaining the electricity of a low-capacity battery after a long idle period. The controlling circuit disconnects a rechargeable battery with a protection circuit when the rechargeable battery is not used.

To achieve the above object, the present invention provides a controlling circuit for retaining electricity, which is connected between a rechargeable battery and a protection circuit and charging the rechargeable battery with an external charger source and composed of a switch, a latch, a controller and a trigger. The switch is connected between the rechargeable battery and the protection circuit in order to connect or disconnect the rechargeable battery from the protection circuit. The latch is connected to a control end of the switch for controlling the turning on and turning off of the switch. The controller is connected to the input end of the latch for generating a first trigger signal to the latch to disconnect the switch and enabling the rechargeable battery in a long-term retention state. The trigger is connected to an input of the external charger source and the latch; the trigger generates a second trigger signal to control the switch to connect the rechargeable battery and the protection circuit when an electrical power is applied to the input end of the external charger source.

### BRIEF DESCRIPTION OF DRAWING

The various objects and advantages of the present invention will be more readily understood from the following detailed description when read in conjunction with the appended drawings, in which:

FIG. 1 shows the block diagram of the preferred embodiment of the present invention;

FIG. 2 shows the block diagram of the controlling circuit;

FIG. 3 shows the circuit diagram of the controlling circuit; and

FIG. 4 shows the controlling circuit for long-time battery retention being connected to an external electrical source.

### DETAILED DESCRIPTION OF THE INVENTION

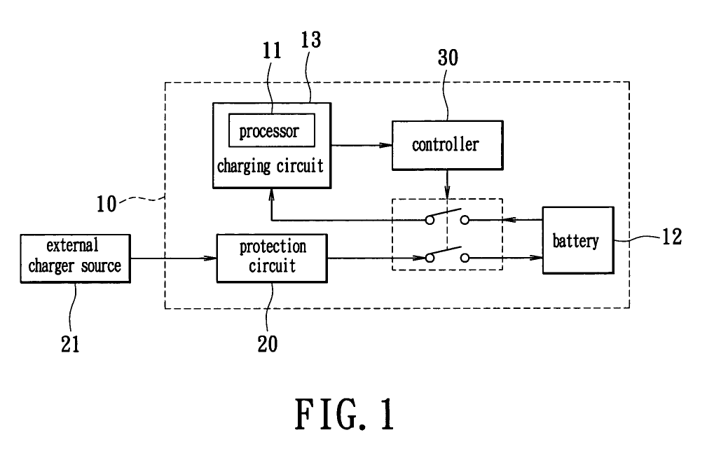

FIG. 1 shows the block diagram of the preferred embodiment of the present invention in which the controlling circuit for long-time battery retention is applied to a Bluetooth™ earphone 10. The Bluetooth™ earphone 10 has a processor 11 to control other elements in the Bluetooth™ earphone 10, a battery 12 (preferably a low capacity rechargeable battery such as Li-ion battery or Ni—H battery) to supply power to the Bluetooth™ earphone 10, and a charging circuit 13. In this embodiment, the rechargeable battery 12 is sealed in the Bluetooth™ earphone 10 and cannot be removed by a user.

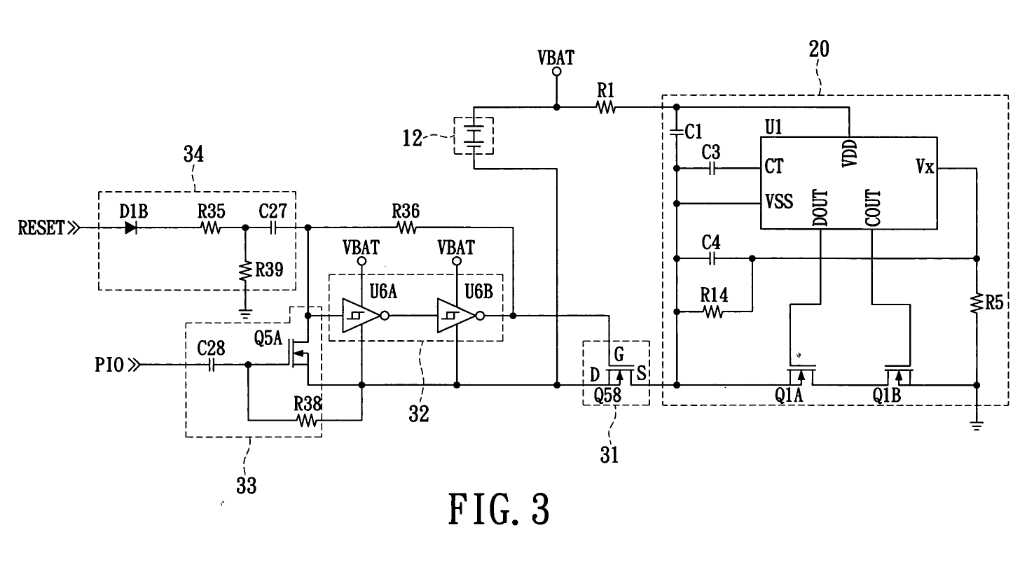

The Bluetooth™ earphone 10 has a protection circuit 20 connected to an external charger source 21. As shown in FIG. 3, the protection circuit 20 has a charging control IC 22 and related components to control a charging current from the external charger source 21 to the rechargeable battery 12.

The Bluetooth™ earphone 10 has a controlling circuit 30 connected between the rechargeable battery 12 and the protection circuit 20 to determine a connection and a disconnection between the rechargeable battery 12 and the protection circuit 20. Moreover, the controlling circuit 30 connected between the rechargeable battery 12 and the protection circuit 20 determines a connection and a disconnection of the charging circuit 13. When the controlling circuit 30 breaks the connection the rechargeable battery 12 and the protection circuit 20 (or the charging circuit 13), the rechargeable battery 12 does not consume electrical power through the protection circuit 20 (or the charging circuit 13) provided that the consumed current 1 μA can be neglected. Therefore, the electricity in the rechargeable battery 12 can be maintained.

Once the external charger source 21 again supplies power to the controlling circuit 30, the controlling circuit 30 will establish the connection between the rechargeable battery 12 and the protection circuit 20 (or the charging circuit 13).

In practice, the controlling circuit 30 can be set to cut the connection of the rechargeable battery 12 with other circuit when the rechargeable battery 12 is first time assembled to the Bluetooth™ earphone 10. When the rechargeable battery 12 is to be charged for first use or charged after a long idle period, the controlling circuit 30 will establish the connection of the rechargeable battery 12 with another circuit, thus ensuring the stored capacity in the rechargeable battery 12.

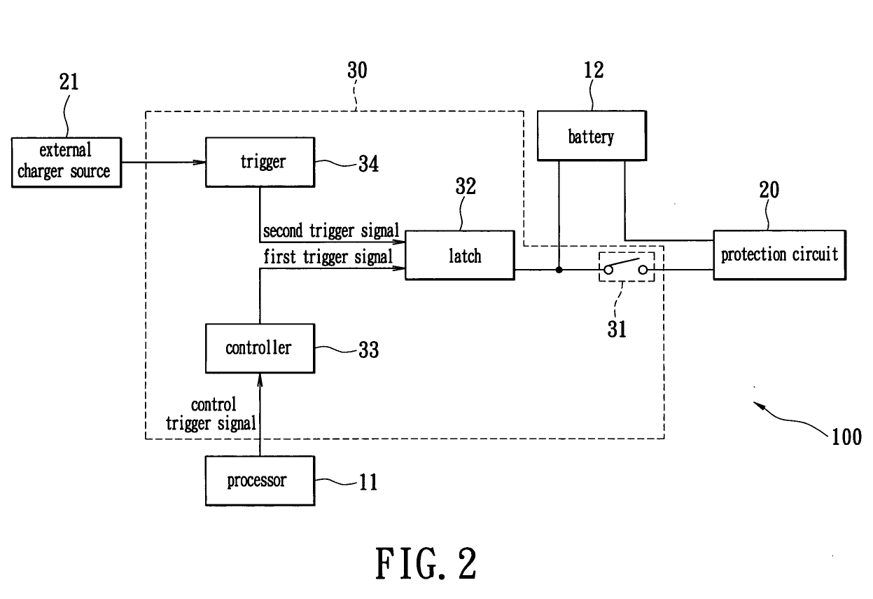

FIG. 2 shows the block diagram of the controlling circuit 30. The controlling circuit 30 comprises a switch 31, a latch 32, a controller 33 and a trigger 34. The switch 31 can connect or disconnect the rechargeable battery 12 with the protection circuit 20. The switch 31 is preferably a MOSFET switch with two switch ends S, D and a control end G.

The latch 32 is used to connect or disconnect the two switch ends S, D of the switch 31 and is preferably a flip-flop composed of two invertors 321. The latch 32 has an input and an output connected to the control end G of the switch 31.

The controller 33 is connected to the input of the latch 32 for sending a first trigger signal to the latch 32 and controlling the disconnection of the switch 31, whereby the rechargeable battery 12 is maintained for long time. The controller 33 is controlled by the processor 11 of the Bluetooth™ earphone 10 and the processor 11 of the Bluetooth™ earphone 10 has a long maintenance time procedure. When the rechargeable battery 12 is to be idled for a long time, the controller 33 is controlled by the processor 11 to send the first trigger signal.

The trigger 34 is connected to the input of the external charger source 21 and the latch 32. The input of the external charger source 21 is preferably a contact or a connector. When an electrical power is fed to the input of the external charger source 21, the trigger 34 sends a second trigger signal to the latch 32 such that the switch 31 will connect the rechargeable battery 12 with the protection circuit 20. When the external charger source 21 is activated by a charger for first-time charging the rechargeable battery 12, or charging the rechargeable battery 12 after a long idle period, the trigger 34 sends the second trigger signal to the latch 32 such that the switch 31 will connect the rechargeable battery 12 with the protection circuit 20.

In the example of Bluetooth™ earphone 10, a push switch can be used to switch the connection or disconnection of the rechargeable battery 12 with the protection circuit 20. For example, if the push switch is pressed for more than 2 minutes, the processor 11 controls the controller 33 to send the first trigger signal and the latch 32 controls the switch 31 to disconnect the rechargeable battery 12 with the protection circuit 20. Therefore, the rechargeable battery 12 will not be exhausted by the protection circuit 20 or the charging circuit 13 after a long idle period.

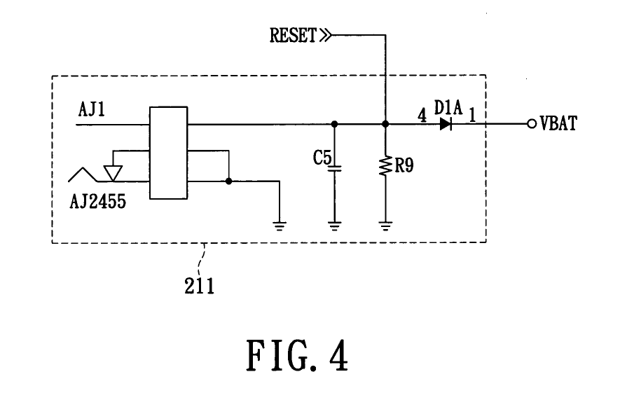

FIG. 4 shows the controlling circuit for long-time battery retention being connected to an external electrical source. A connection interface 211 is provided between the trigger 34 and the external charger source 21. When the external charger source 21 is connected to the controlling circuit, the reset end of the trigger 34 is at logic high level such that the trigger 34 sends the second trigger signal to the latch 32 to turn on the switch 31. In other words, the rechargeable battery 12 can be normally charged by connecting with the external charger source 21 after a long idle period.

To sum up, the controlling circuit for long-time battery retention according to the present invention can sustain the electrical capacity of a rechargeable battery for a long idle period. Moreover, the controlling circuit for long-term battery retention according to the present invention is implemented by a simple logic circuit

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

1. A controlling circuit for long-time battery retention, the controlling circuit connected between a rechargeable battery and a protection circuit and charging the rechargeable battery with an external charger source, wherein the controlling circuit comprises:
a switch having a control end and two switch ends connected between the rechargeable battery and the protection circuit in order to connect or disconnect the rechargeable battery from the protection circuit;
a latch having an input end and an output end connected to the control end of the switch for controlling the connection and disconnection between the two switch ends of the switch;
a controller connected to the input end of the latch for generating a first trigger signal to the latch to disconnect the switch and enabling the rechargeable battery in a long-term retention state; and
a trigger connected to an input end of the external charger source and the latch, the trigger generating a second trigger signal to control the switch to connect the rechargeable battery and the protection circuit when electrical power is applied to the input end of the external charger source.

2. The controlling circuit for long-time battery retention as in claim 1, wherein the rechargeable battery is a low-capacity rechargeable battery.

3. The controlling circuit for long-time battery retention as in claim 1, wherein the external charger source is a charging power source.

4. The controlling circuit for long-time battery retention as in claim 1, wherein the protection circuit comprises at least a charging control IC to control a charging current for the rechargeable battery.

5. The controlling circuit for long-time battery retention as in claim 1, wherein the switch is a MOSFET switch.

6. The controlling circuit for long-time battery retention as in claim 1, wherein the latch is a flip-flop composed of two inverters.

7. The controlling circuit for long-time battery retention as in claim 1, wherein the controller generates the first trigger signal under the control of a processor.

8. The controlling circuit for long-time battery retention as in claim 7, wherein the processor has a long maintenance time procedure to control the controller for generating the first trigger signal.

9. The controlling circuit for long-time battery retention as in claim 1, wherein the input end of the external charger source is preferably a contact or a connector.
